(19) United States
(12) Patent Application Publication
(10) Pub. No.: US 2025/0183664 A1
(43) Pub. Date: Jun. 5, 2025

(54) SYSTEMS AND METHODS FOR UNIFIED POWER FLOW CONTROLLER IMPLEMENTATION

(71) Applicant: SCHNEIDER ELECTRIC IT CORPORATION, Foxboro, MA (US)

(72) Inventor: Ilknur Colak, Regensburg (DE)

(21) Appl. No.: 18/962,494

(22) Filed: Nov. 27, 2024

Related U.S. Application Data
(60) Provisional application No. 63/604,505, filed on Nov. 30, 2023.

(51) Int. Cl. H02J 3/16; H02J 3/00; H02J 3/48

(52) U.S. Cl. CPC H02J 3/16; H02J 3/00125; H02J 3/48; H02J 2203/10

(57) ABSTRACT

Examples of the disclosure include a power system having a first converter configured to be coupled in parallel with a power transmission line, the first converter including a plurality of shunt sub-modules configured to be coupled in series between the power transmission line and a reference node, a second converter configured to be coupled in series with the power transmission line, the second converter including a plurality of series sub-modules coupled in parallel with each other, and a common DC bus coupled to the first converter and the second converter.

### CROSS-REFERENCE TO RELATED APPLICATIONS

This application claims priority under 35 U.S.C. § 119 (e) to U.S. Provisional Application Ser. No. 63/604,505, titled “SYSTEMS AND METHOD FOR UNIFIED POWER FLOW CONTROLLER IMPLEMENTATION,” filed on Nov. 30, 2023, which is hereby incorporated by reference in its entirety.

### BACKGROUND

### 1. Field of the Disclosure At least one example in accordance with the present disclosure relates generally to power systems.

### 2. Discussion of Related Art

Power systems may include power sources and loads connected by transmission lines. Power sources provide power to the loads via the transmission lines. Power characteristics, such as current, voltage, and so forth, may vary from nominal levels over time. For example, current and/or voltage levels may deviate from nominal levels as additional loads are added or removed.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure, a power system is provided including a first converter configured to be coupled in parallel with a power transmission line, the first converter including a plurality of shunt sub-modules configured to be coupled in series between the power transmission line and a reference node; a second converter configured to be coupled in series with the power transmission line, the second converter including a plurality of series sub-modules coupled in parallel with each other; and a common DC bus coupled to the first converter and the second converter.

In at least one example, the first converter and the second converter are configured to be coupled to a multi-phase power transmission line. In at least one example, the first converter and the second converter are configured to be coupled to a three-phase power transmission line. In at least one example, the first converter and the second converter are configured to be coupled to a single-phase power transmission line. In at least one example, the system includes at least one controller coupled to the first converter and the second converter and being configured to control at least one of the first converter or the second converter to buck a voltage on the power transmission line. In at least one example, the at least one controller is configured to control the second converter to buck the voltage on the power transmission line.

In at least one example, the system includes at least one controller coupled to the first converter and the second converter and being configured to control at least one of the first converter or the second converter to boost a voltage on the power transmission line. In at least one example, the at least one controller is configured to control the second converter to boost the voltage on the power transmission line. In at least one example, the system includes at least one controller coupled to the first converter and the second converter and being configured to control at least one of the first converter or the second converter to inject reactive power to the power transmission line. In at least one example, the system includes at least one controller coupled to the first converter and the second converter and being configured to control at least one of the first converter or the second converter to absorb reactive power from the power transmission line.

In at least one example, the system includes at least one controller coupled to the first converter and the second converter and being configured to control at least one of the first converter or the second converter to inject active power to the power transmission line. In at least one example, the system includes at least one controller coupled to the first converter and the second converter and being configured to control at least one of the first converter or the second converter to absorb active power from the power transmission line. In at least one example, the system includes at least one controller coupled to the first converter and the second converter and being configured to control at least one of the first converter or the second converter to adjust a phase angle between a voltage and a current on the power transmission line.

In at least one example, the system includes at least one controller coupled to the first converter and the second converter and being configured to control at least one of the first converter or the second converter to adjust an impedance on the power transmission line. In at least one example, the system includes at least one controller coupled to the first converter and the second converter and being configured to control at least one of the first converter or the second converter to damp power oscillations on the power transmission line. In at least one example, the system includes at least one controller coupled to the first converter and the second converter and being configured to control at least one of the first converter or the second converter to filter harmonics on the power transmission line.

In at least one example, each shunt sub-module of the plurality of shunt sub-modules includes a respective isolated bi-directional AC/DC converter. In at least one example, each isolated bi-directional AC/DC converter includes an isolating transformer. In at least one example, the isolating transformer includes a solid-state transformer. In at least one example, each series sub-module of the plurality of series sub-modules includes a respective isolated bi-directional AC/DC converter. In at least one example, each isolated bi-directional AC/DC converter includes an isolating transformer. In at least one example, the isolating transformer includes a solid-state transformer. In at least one example, each isolating transformer includes a winding coupled directly to the power transmission line. In at least one example, each series sub-module of the plurality of series sub-modules further includes at least one switching network, and wherein each isolating transformer includes a winding coupled to the power transmission line through the at least one switching network.

Examples of the disclosure include a method of controlling a power device including a first converter configured to be coupled in parallel with a power transmission line, the first converter including a plurality of shunt sub-modules configured to be coupled in series between the power transmission line and a reference node, and a second converter configured to be coupled in series with the power transmission line, the second converter including a plurality of series sub-modules coupled in parallel with each other, the method comprising: drawing, by at least one of the plurality of shunt sub-modules or the plurality of series sub-modules, power from the power transmission line; and providing, by the at least one of the plurality of shunt sub-modules or the plurality of series sub-modules, the drawn power to a common DC bus between the first converter and the second converter.

Examples of the disclosure include at least one non-transitory computer-readable medium storing thereon sequences of computer-executable instructions for controlling a power device including a first converter configured to be coupled in parallel with a power transmission line, the first converter including a plurality of shunt sub-modules configured to be coupled in series between the power transmission line and a reference node, and a second converter configured to be coupled in series with the power transmission line, the second converter including a plurality of series sub-modules coupled in parallel with each other, the sequences of computer-executable instructions including instructions that instruct at least one processor to: control at least one of the plurality of shunt sub-modules or the plurality of series sub-modules to draw power from the power transmission line; and control the at least one of the plurality of shunt sub-modules or the plurality of series sub-modules to provide the drawn power to a common DC bus between the first converter and the second converter.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram, of a power system according to an example;

FIG. 2 illustrates a block diagram of a power system according to an example;

FIG. 3 illustrates a block diagram of a power system according to an example;

FIG. 4 illustrates a block diagram of a sub-module according to an example; and

FIG. 5 illustrates a block diagram of a power system according to another example.

### DETAILED DESCRIPTION

As discussed above, power systems may include power sources and loads connected via transmission lines. Power characteristics on the transmission lines, such as voltage levels and harmonic content, may fluctuate over time. Some power systems may include devices that provide power compensation to counteract undesirable power-characteristic fluctuations. For example, a unified power flow controller is a power device that can provide power compensation to the transmission lines to control active and reactive power flows in the transmission lines.

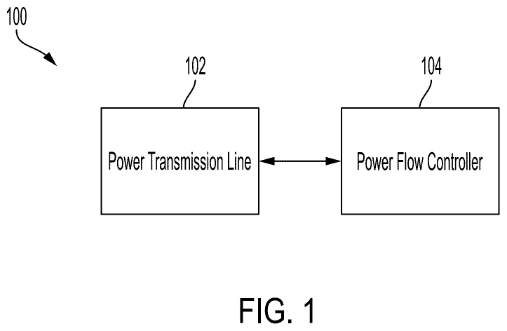

FIG. 1 illustrates a block diagram of a power system 100 according to an example. The power system 100 includes a power transmission line 102 and a unified power flow controller (UPFC) 104. The power transmission line 102 may include or be coupled to a power source, such as a utility grid, and to one or more loads. The power transmission line 102 may transmit single-phase power or multi-phase power (for example, three-phase power). The UPFC 104 may include one or more converters to control active and reactive power flows on the power transmission line 102. For example, the UPFC 104 may include a shunt converter coupled in parallel with the power transmission line 102 and a series converter coupled in series with the power transmission line 102.

The UPFC 104 may operate the series and shunt converters to maintain certain power characteristics on the power transmission line 102. For example, if the voltage on the power transmission line 102 exceeds a nominal value, then the UPFC 104 may operate the series converter to draw current from the power transmission line 102 and provide the current to the shunt converter, and may operate the shunt converter to feed voltage back to the power transmission line 102 at a desired voltage. Similarly, if the voltage on the power transmission line 102 is less than a nominal value, then the UPFC 104 may operate the shunt converter to draw current from the power transmission line 102 and provide the current to the series converter, and may operate the series converter to generate a voltage in series with the power transmission line 102 to increase the voltage on the power transmission line 102.

Accordingly, by interacting with the power on the power transmission line 102, the UPFC 104 can modify voltage levels, filter out harmonics, inject or absorb active and/or reactive power, and so forth. Examples of the disclosure provide a unified power flow controller having an arbitrary number of sub-modules. An example unified power flow controller includes a series converter having an arbitrary number of sub-modules and a shunt converter having an arbitrary number of sub-modules. Each sub-module may include an isolated bi-directional AC/DC converter, which may include a transformer (for example, a solid-state transformer) and associated switching networks. Sub-modules may be added or removed to increase the power capacity of the unified power flow controller, adapt to the voltage levels on the power transmission line, provide redundancy, and so forth. The unified power flow controller may be operated to regulate voltage levels on a grid (for example, by bucking and/or boosting voltage levels), inject or absorb active and/or reactive power to improve or maintain power factor, adjust the phase angle between the voltage and/or current on the grid, dynamically change line impedance, damp power oscillations on the grid, filter harmonics, provide bidirectional power flow, improve efficiency, provide grid voltage and/or frequency support, and so forth. In some examples, the converters may be connected via a common power bus. The common power bus may further be connected to additional power devices such as power sources (for example, solar-power generators), energy-storage devices (for example, batteries), loads (for example, servers), a combination thereof, and so forth.

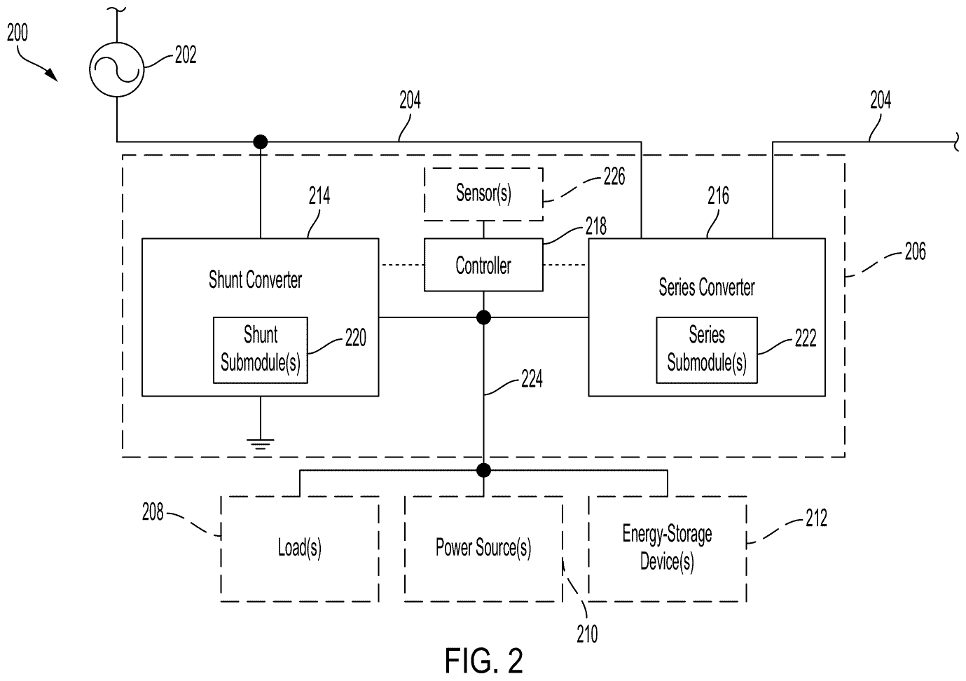

FIG. 2 illustrates a block diagram of a power system 200 according to an example. The power system 200 includes an AC power source 202, a transmission line 204, a unified power flow controller (UPFC) 206, and, optionally, one or more loads 208 (“loads 208”), one or more power sources 210 (“power sources 210”), and one or more energy-storage devices 212 (“energy-storage devices 212”). The UPFC 206 includes a shunt converter 214, a series converter 216, and at least one controller 218 (“controller 218”). The shunt converter 214 includes one or more shunt sub-modules 220. The series converter 216 includes one or more series sub-modules 222.

The AC power source 202, which may be or include a utility mains, provides power to the transmission line 204, which may be a utility grid. The transmission line 204 may provide single-phase power or multi-phase power (for example, three-phase power). The shunt converter 214 is coupled in parallel with the transmission line 204 between the transmission line 204 and a reference node (for example, neutral). The series converter 216 is coupled in series with the transmission line 204. The shunt converter 214 is coupled to the series converter 216 via a common DC bus 224. In examples in which the loads 208, the power sources 210, and/or the energy-storage devices 212 are included, each included component may also be coupled to the converters 214, 216 via the common DC bus 224.

The controller 218 is configured to monitor power characteristics of the transmission line 204. For example, the UPFC 206 may include or be coupled to one or more sensors 226 (“sensors 226”), which may sense power information such as current information, voltage information, and so forth. In some examples, the UPFC 206 may include one or more of the sensors 226, and in various examples, one or more of the sensors 226 may be external to the UPFC 226.

The controller 218 may receive power information from the sensors 226 to determine voltage and/or current characteristics of power on the transmission line 204. If power characteristics such as voltage, current, harmonic content, active and/or reactive power, or other power characteristics deviate from a respective range of nominal values, the controller 218 may operate the converters 214, 216 to modify the power characteristics. For example, the controller 218 may operate the converters 214, 216 to increase or decrease voltage levels, inject or absorb active and/or reactive power, modify the harmonic content of voltage on the transmission line 204, and so forth.

A number of shunt sub-modules 220 and series sub-modules 222 may be selected based on various design considerations. For example, the shunt sub-modules 220 may be coupled in series with each other in parallel with the transmission line 204. Accordingly, the series combination of shunt sub-modules 220 may be subject to the entire voltage of the transmission line 204. Because the shunt sub-modules 220 are coupled in series with each other in this example, adding additional shunt sub-modules 220 may reduce the voltage drop across each individual sub-module. For example, doubling the number of shunt sub-modules 220 may reduce the voltage dropped across each shunt sub-module 220 in half. Similarly, the DC-bus-connections of each of the shunt sub-modules 220 may be coupled in parallel to the common DC bus 224. Adding additional shunt sub-modules 220 may therefore increase the power capacity of the shunt sub-modules 220 to the common DC bus 224. In some examples, one or more additional sub-modules may also be added to provide redundancy. For example, if a sub-module needs to be taken out of operation (for maintenance or in response to an error condition, for example), the sub-module can be bypassed and a redundant sub-module may be switched in.

Similar principles apply to the series sub-modules 222. The series sub-modules 222 may be coupled in series with the transmission line 204 and in parallel with each other. Adding additional series sub-modules 222 may therefore reduce a current load of each of the individual series sub-modules 222. Similarly, the DC-bus-connections of each of the series sub-modules 222 may be coupled in parallel to the common DC bus 224. Adding additional series sub-modules 222 may therefore increase the power capacity of the series sub-modules 222 in providing power to the common DC bus 224. In some examples, one or more additional sub-modules may also be added to provide redundancy.

The optional loads 208 may be included in some examples. In examples in which the loads 208 are included, the loads 208 may be coupled to the converters 214, 216 via the common DC bus 224. In some examples, the loads 208 may be coupled to the power sources 210 and/or the energy-storage devices 212 via the common DC bus 224. The controller 218 may control the converters 214, 216 to provide power to the loads 208. The loads 208 may include devices that draw electrical power. As discussed below, in some examples the loads 208 may include one or more power-supply units (PSUs) each coupled to one or more information-technology (IT) devices, such as computer servers.

The optional power sources 210 may be included in some examples. In examples in which the power sources 210 are included, the power sources 210 may be coupled to the converters 214, 216 via the common DC bus 224. In some examples, the power sources 210 may be coupled to the loads 208 and/or the energy-storage devices 212 via the common DC bus 224. The power sources 210 may include sources of electrical power, such as solar panels, wind turbines, hydroelectric-power sources, and so forth. In some examples, the power sources 210 may include or be coupled to the common DC bus 224 via at least one power converter, such as a DC/DC converter. The controller 218 may control the converters 214, 216 to draw power from the power sources 210 and provide the drawn power to the loads 208, back to the transmission line 204, to the energy-storage devices 212, or a combination thereof.

The optional energy-storage devices 212 may be included in some examples. In examples in which the energy-storage devices 212 are included, the energy-storage devices 212 may be coupled to the converters 214, 216 via the common DC bus 224. The energy-storage devices 212 may include storage devices for storing electrical energy, such as batteries, capacitors, flywheels, and so forth. In some examples, the energy-storage devices 212 may include or be coupled to the common DC bus 224 via at least one power converter, such as a DC/DC converter. The controller 218 may control the converters 214, 216 to draw stored power from the energy-storage devices 212 and provide the drawn power to the loads 208, and/or back to the transmission line 204, and/or to the loads 208, and/or a combination thereof. The controller 218 may additionally or alternatively control the converters 214, 216 to recharge the energy-storage devices 212 with power drawn from the transmission line 204, the power sources 210, a combination thereof, and so forth.

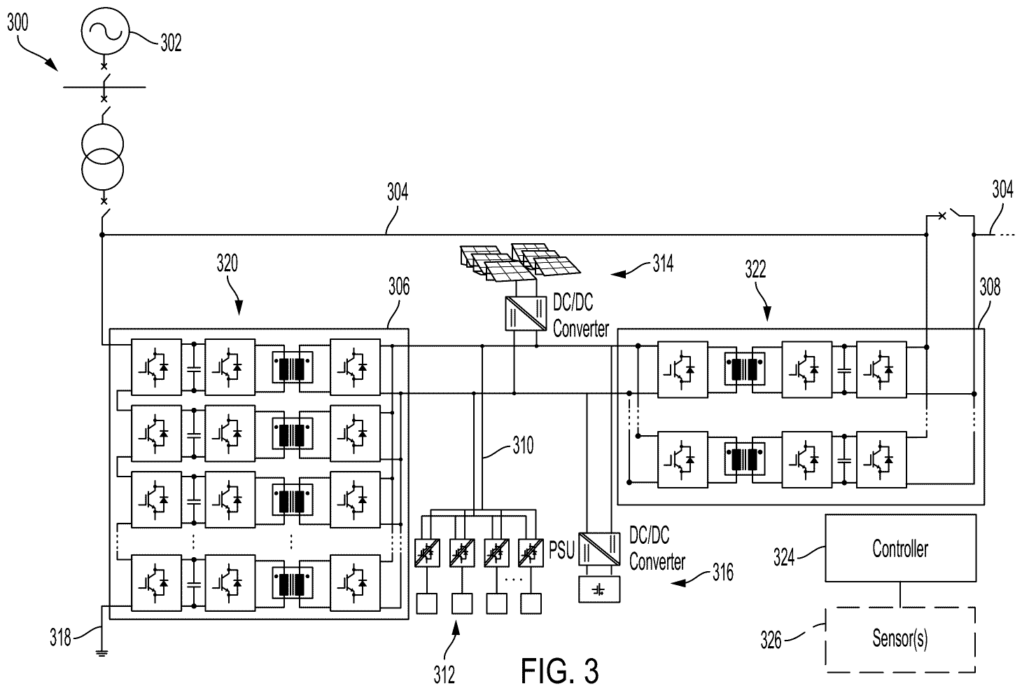

FIG. 3 illustrates a block diagram of a power system 300 according to an example. The power system 300 may illustrate one example of the power system 200. The power system 300 includes an AC power source 302, a transmission line 304, a UPFC including a shunt converter 306 and a series converter 308 coupled by a common DC bus 310, an arbitrary number of loads 312, an arbitrary number of DC power sources 314, and an arbitrary number of energy-storage devices 316. The shunt converter 306 is coupled to a reference node 318 (for example, a return node) and includes an arbitrary number of shunt sub-modules 320. The series converter 308 includes an arbitrary number of series sub-modules 322. In some examples, the UPFC further includes at least one controller 324 (“controller 324”). The controller 324 may be an example of the controller 218. In various examples, the power system 300 may optionally include one or more sensors 326 (“sensors 326”), which may include one or more sensors such as current and/or voltage sensors.

In at least one example, the AC power source 302 includes a utility power source configured to distribute power to loads via the transmission line 304. The controller 324 may control the converters 306, 308 to interact with power on the transmission line 304. For example, the controller may control switching devices of any of the sub-modules 320, 322 to draw power from the transmission line 304 to the common DC bus 310, or to draw power from the common DC bus 310 to the transmission line 304. Power drawn the common DC bus 310 may be drawn from the DC power sources 314 or the energy-storage devices 316. Power provided to the common DC bus 310 may be provided to the loads 312 or the energy-storage devices 316. The sensors 326 may sense power information, such as voltage and/or current information, at desired locations within the power system 300. The sensors 326 may provide sensed information to the controller 324.

The loads 312 include devices configured to consume electrical power, such as data servers. The loads 312 may include any number and variety of loads. The DC power sources 314 may include any sources of DC power, such as solar panels, wind turbines, hydroelectric-power sources, and so forth. In some examples, the DC power sources 314 may include or be coupled to one or more DC/DC converters coupled to the common DC bus 310. In various examples, the common DC bus 310 may additionally or alternatively be coupled to one or more AC power sources coupled to the common DC bus 310 via one or more AC/DC converters. The energy-storage devices 316 may include one or more batteries, capacitors, flywheels, or other energy-storage devices. In some examples, the energy-storage devices 316 may include or be coupled to one or more DC/DC converters coupled to the common DC bus 310.

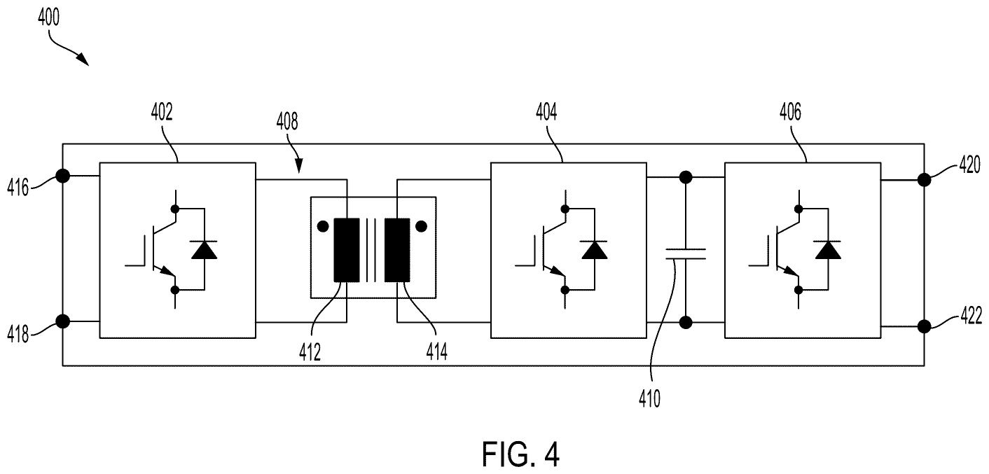

FIG. 4 illustrates a block diagram of a sub-module 400 according to an example. The sub-module 400 may be an example of one of the shunt sub-modules 320 and/or one of the series sub-modules 322. In various examples, each of the shunt sub-modules 320 is structurally similar or identical to each other and to each of the series sub-modules 322. However, the sub-module 400 may be electrically coupled in different configurations to a power system (for example, the power system 300) which may dictate the function and/or operation of the sub-module 400 as discussed below.

The sub-module 400 includes a first switching network 402 (“first switch 402”), a second switching network 404 (“second switch 404”), a third switching network 406 (“third switch 406”), a transformer 408, and a capacitor 410. Each of the switches 402-406 may include one or more switches. The sub-module 400 may be an isolated AC/DC bidirectional converter. The transformer 408, which may be an isolating transformer (for example, a solid-state transformer), includes a first winding 412 and a second winding 414. The sub-module 400 further includes a first connection 416, a second connection 418, a third connection 420, and a fourth connection 422.

The first switch 402 is coupled to the first connection 416, the second connection 418, and the first winding 412. The second switch 404 is coupled to the second winding 414, the third switch 406, and the capacitor 410. The third switch 406 is coupled to the second switch 404, the capacitor 410, the third connection 420, and the fourth connection 422. The capacitor 410 is coupled to the second switch 406 and the third switch 408. The first winding 412 is coupled to the first switch 402, and is inductively coupled to the second winding 414. The second winding 414 is coupled to the second switch 406, and is inductively coupled to the first winding 412.

The third connection 420 and the fourth connection 422 are coupled to the third switch 406. The connections 420, 422 may further be coupled to different entities depending on the implementation of the sub-module 400. For example, if the sub-module 400 is implemented in the shunt converter 320, then the third connection 420 may be coupled to the transmission line 304 and the fourth connection 422 may be coupled to another sub-module (for example, coupled in series with a corresponding third connection of the other sub-module similar to the third connection 420). If the sub-module 400 is implemented in the series converter 322, then the connections 420, 422 may both be coupled in series with the transmission line 304.

The first connection 416 and the second connection 418 are coupled to the first switch 402. The connections 416, 418 may further be coupled to the common DC bus 310. As illustrated in the example of FIG. 3, multiple sub-modules may be coupled in parallel via respective first and second connections similar to the first connection 416 and the second connection 418. For example, the first connection 416 may be coupled to a higher-voltage bus of the common DC bus 310, and the second connection 418 may be coupled to a lower-voltage bus of the common DC bus 310.

The controller 324 may control the switches 402-406 to exchange power between the common DC bus 310 and the transmission line 304. For example, to provide power from the common DC bus 310 to the transmission line 304 using the sub-module 400, the controller 324 may control the first switch 402 to draw DC power from the common DC bus 310 via the connections 416, 418, convert the DC power to AC power, and provide the AC power to the first winding 412. The first winding 412 may act as a primary winding in response to receiving the AC power and induce power in the second winding 414, which may act as a secondary winding. The second winding 414 may provide induced AC power to the second switch 404. The controller 324 may operate the second switch 404 to convert the induced AC power to DC power, and charge the capacitor 410 with the DC power. The controller 324 may operate the third switch 406 to draw DC power from the capacitor 410, convert the DC power to AC power, and provide the AC power to the transmission line 304 via the connections 420, 422.

To provide power from the transmission line 304 to the common DC bus 310 using the sub-module 400, the controller 324 may control the third switch 406 to draw AC power from the transmission line 304 via the connections 420, 422, convert the AC power to DC power, and provide the DC power to the capacitor 410. The controller 324 may control the second switch 404 to draw DC power from the capacitor 410, convert the DC power to AC power, and provide the AC power to the second winding 414. The second winding 414 may act as a primary winding in response to receiving the AC power and induce power in the first winding 412, which may act as a secondary winding. The first winding 412 may provide the induced AC power to the first switch 402. The controller 324 may control the first switch 402 to convert the AC power to DC power and provide the DC power to the common DC bus 310 via the connections 416, 418.

In various examples, each of the switching networks 402-406 may include one or more switches arranged to operate as a bi-directional AC/DC converter. Each of the switches may be communicatively coupled to the controller 324. The controller 324 may provide control signals to each switch to control a switching state of each respective switch.

The controller 324 may operate the converters 306, 308 to provide power to the loads 312 and/or energy-storage devices 316 in addition to, or in lieu of, managing power characteristics of the transmission line 304. In some examples, the controller 324 may control the power provided to the loads 312 and/or energy-storage devices 316 based at least in part on the power characteristics. For example, the controller 324 may include or be coupled to one or more voltage sensor configured to sense voltage information on the transmission line 304 and control the power to the loads 312 and/or the energy-storage devices 316 based on the sensed voltage information.

For example, if the voltage on the transmission line 304 is within a rated range (for example, within 10% of a rated voltage value), then the controller 324 may control the converters 306, 308 to share a current draw from the transmission line 304 to power the loads 312 and/or energy-storage devices 316. If the voltage on the transmission line 304 exceeds the rated range, then the controller 324 may control at least one of the converters 306, 308 to provide a majority of current to the loads 312 and/or energy-storage devices 316 (for example, up to a rated output current of the converters 306, 308) and to control the other of the converters 306, 308 to provide a minority of the current. If the voltage on the transmission line 304 falls below the rated range, then the controller 324 may control the shunt converter 306 to provide power to the loads 312 and/or energy-storage devices 316, and may control the series converter 308 to increase a voltage on the transmission line 304 (for example, by adding additional voltage in series with the transmission line 304). If the loads 312 are not drawing any power, then the controller 324 may control the shunt converter 306 to feed power back to the transmission line 304.

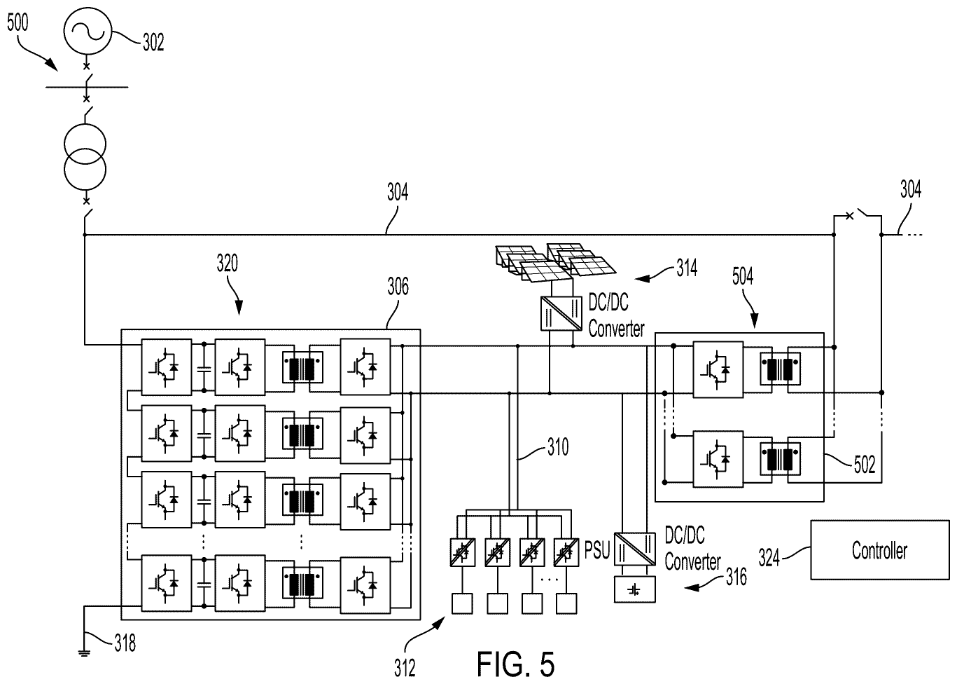

In different examples, different sub-modules may be implemented in the sub-modules 220, 222. For example, FIG. 5 illustrates a block diagram of a power system 500 according to an example. The power system 500 is substantially similar to the power system 300, and like components are labeled accordingly. The power system 500 includes a series converter 502 which may differ from the series converter 308. For example, the series converter 502 includes an arbitrary number of series sub-modules 504, which may be different than the series sub-modules 322.

Whereas each of the series sub-modules 322 may be implemented pursuant to the example of FIG. 4, the series sub-modules 504 may omit the second switch 404, the third switch 406, and the capacitor 410. Accordingly, in the series-submodules 504, the second winding 414 may be coupled directly to the transmission line 304 via the connections corresponding to the connections 420, 422 of FIG. 4. The transmission line 304 may therefore directly exchange AC power with the second winding 414. In various examples, the series sub-modules 504 of FIG. 5 may each implement a low-frequency solid-state transformer, whereas the transformer 408 of FIG. 4 may implement a mid-or high-frequency solid-state transformer. Operation of the sub-modules 400, 504 may otherwise be substantially similar.

Various controllers, such as the controller 218 and/or 324, may execute various operations discussed above. The controller 218, 324 may also execute one or more instructions stored on one or more non-transitory computer-readable media, which the controller 218, 324 may include and/or be coupled to, which may result in manipulated data. The non-transitory computer-readable media may include memory and/or storage. In some examples, the controller 218, 324 may include one or more processors or other types of controllers. In one example, the controller 218, 324 is or includes at least one processor. In another example, the controller 218, 324 performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A power system including:
a first converter configured to be coupled in parallel with a power transmission line, the first converter including a plurality of shunt sub-modules configured to be coupled in series between the power transmission line and a reference node;
a second converter configured to be coupled in series with the power transmission line, the second converter including a plurality of series sub-modules coupled in parallel with each other; and
a common DC bus coupled to the first converter and the second converter.

2. The power system of claim 1, further comprising at least one controller coupled to the first converter and the second converter and being configured to control at least one of the first converter or the second converter to buck a voltage on the power transmission line.

3. The power system of claim 2, wherein the at least one controller is configured to control the second converter to buck the voltage on the power transmission line.

4. The power system of claim 1, further comprising at least one controller coupled to the first converter and the second converter and being configured to control at least one of the first converter or the second converter to boost a voltage on the power transmission line.

5. The power system of claim 4, wherein the at least one controller is configured to control the second converter to boost the voltage on the power transmission line.

6. The power system of claim 1, further comprising at least one controller coupled to the first converter and the second converter and being configured to control at least one of the first converter or the second converter to inject reactive power to the power transmission line.

7. The power system of claim 1, further comprising at least one controller coupled to the first converter and the second converter and being configured to control at least one of the first converter or the second converter to absorb reactive power from the power transmission line.

8. The power system of claim 1, further comprising at least one controller coupled to the first converter and the second converter and being configured to control at least one of the first converter or the second converter to inject active power to the power transmission line.

9. The power system of claim 1, further comprising at least one controller coupled to the first converter and the second converter and being configured to control at least one of the first converter or the second converter to absorb active power from the power transmission line.

10. The power system of claim 1, further comprising at least one controller coupled to the first converter and the second converter and being configured to control at least one of the first converter or the second converter to adjust a phase angle between a voltage and a current on the power transmission line.

11. The power system of claim 1, wherein each shunt sub-module of the plurality of shunt sub-modules includes a respective isolated bi-directional AC/DC converter.

12. The power system of claim 11, wherein each isolated bi-directional AC/DC converter includes an isolating transformer.

13. The power system of claim 12, wherein the isolating transformer includes a solid-state transformer.

14. The power system of claim 1, wherein each series sub-module of the plurality of series sub-modules includes a respective isolated bi-directional AC/DC converter.

15. The power system of claim 14, wherein each isolated bi-directional AC/DC converter includes an isolating transformer.

16. The power system of claim 15, wherein the isolating transformer includes a solid-state transformer.

17. The power system of claim 16, wherein each isolating transformer includes a winding coupled directly to the power transmission line.

18. The power system of claim 17, wherein each series sub-module of the plurality of series sub-modules further includes at least one switching network, and wherein each isolating transformer includes a winding coupled to the power transmission line through the at least one switching network.

19. A method of controlling a power device including a first converter configured to be coupled in parallel with a power transmission line, the first converter including a plurality of shunt sub-modules configured to be coupled in series between the power transmission line and a reference node, and a second converter configured to be coupled in series with the power transmission line, the second converter including a plurality of series sub-modules coupled in parallel with each other, the method comprising:
drawing, by at least one of the plurality of shunt sub-modules or the plurality of series sub-modules, power from the power transmission line; and
providing, by the at least one of the plurality of shunt sub-modules or the plurality of series sub-modules, the drawn power to a common DC bus between the first converter and the second converter.

20. At least one non-transitory computer-readable medium storing thereon sequences of computer-executable instructions for controlling a power device including a first converter configured to be coupled in parallel with a power transmission line, the first converter including a plurality of shunt sub-modules configured to be coupled in series between the power transmission line and a reference node, and a second converter configured to be coupled in series with the power transmission line, the second converter including a plurality of series sub-modules coupled in parallel with each other, the sequences of computer-executable instructions including instructions that instruct at least one processor to:
control at least one of the plurality of shunt sub-modules or the plurality of series sub-modules to draw power from the power transmission line; and
control the at least one of the plurality of shunt sub-modules or the plurality of series sub-modules to provide the drawn power to a common DC bus between the first converter and the second converter.
